(19) United States
(12) Patent Application Publication
(10) Pub. No.: US 2022/0297271 A1
(43) Pub. Date: Sep. 22, 2022

(54) Multiple Angle Adjustable Wrench

(71) Applicant: Kevin Chase, Bennett (US)

(72) Inventor: Kevin Chase, Bennett (US)

(21) Appl. No.: 17/204,808

(22) Filed: Mar. 17, 2021

(51) Int. Cl. B25B 23/00; B25B 13/04; B25B 13/08

(52) U.S. Cl. CPC B25B 23/0028; B25B 13/04; B25B 13/08

(57) ABSTRACT

A hand tool for providing a hand tool for providing a multiple angle adjusting wrench according to the present invention. The wrench includes the three segments: an open wrench segment, a center section segment, and a closed wrench segment. It also includes two pivot points where the wrench segments are coupled to the center section segment. A gear-spring combination is used to lock the segments into a desired orientation while permitting easy reconfiguration of the wrench.

### TECHNICAL FIELD

This application relates in general to an article of manufacture for providing an multiple angle adjustable wrench.

### DESCRIPTION OF RELATED ART

Mechanics and individuals of all types use wrenches to secure items using by applying torque to turn an object, such as bolts, nuts, fasteners and fittings. These devices are typically located in a position that best holds the components of an item together rather than in a position that makes tightening and loosening of the object easy. Wrenches that assist individuals in tightening and loosening objects are made in many shapes, sizes and orientations. In order to access object in all locations, typically multiple differently shaped wrenches are needed. This requirement to buy, store, organize, and transport multiple wrenches in a plurality of different sizes is a waste of money, resources, and effort. A need exists for a wrench that adjusts into many orientations for a given wrench size that permits individuals to use just one wrench in place of many different wrenches.

The present invention attempts to address the existing limitations of wrenches and objects that require differing orientations to effecting tighten and loosen, according to the principles and example embodiments disclosed herein.

### SUMMARY

In accordance with the present invention, the above and other problems are solved by providing a wrench that can provide multiple angles and adjustments.

In one embodiment, the present invention providing one hand tool to replace multiple other wrenches and or modifications of other wrenches for any user. The wrench 100 includes the three segments: the open wrench segment 101, the center section segment 102, and the closed wrench segment 103. It also includes two pivot points where the wrench segments are coupled to the center section segment. A gear-spring combination is used to lock the segments into a desired orientation while permitting easy reconfiguration of the wrench.

The great utility of the invention is that the hand tool may providing a hand tool for providing a multiple angle adjusting wrench in place of a plurality of similarly sized wrenches.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment a three-segment wrench that provides multiple angles and adjustments according to the present invention.

FIG. 2 illustrates another potential embodiment a three wrench that provides multiple angles and adjustments according to the present invention.

FIG. 3 illustrates one potential embodiment an exploded view of the components in an embodiment of three segment wrench that provides multiple angles and adjustments to the present invention.

FIG. 4 illustrates one potential embodiment a two-segment wrench that provides multiple angles and adjustments according to the present invention.

FIG. 5 illustrates another potential embodiment a two wrench that provides multiple angles and adjustments according to the present invention.

FIG. 6 illustrates one potential embodiment an exploded view of the components in an embodiment of two segment hand tool for providing a wrench that provides multiple angles and adjustments according to the present invention.

### DETAILED DESCRIPTION

This application relates in general an article of manufacture for providing a wrench that can provide multiple angles and adjustments for any user.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and subranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “hand tool” refers to a wrench for tightening and loosening nuts and bolts by an individual. The hand tool is adjusted into many different orientations while still providing needed leverage to tighten and loosen nuts and bolts.

The term “user” and “mechanic” refers to an entity, e.g., a human, that operates a device according to the present invention in order to bring about a desired effect or outcome, particularly provide the user and adjustable wrench. In a particular case, the user is one that is uses a wrench. For such a user, the terms “user” and “mechanic” may be used herein interchangeably.

The term “Spring” refers to the functions in a spring mechanism that compresses, extends, rotates, slides, pulls and exerts force when an equal or greater force is applied. A spring mechanism can exert pressure, rotational force or pulling strength in a variety of ways.

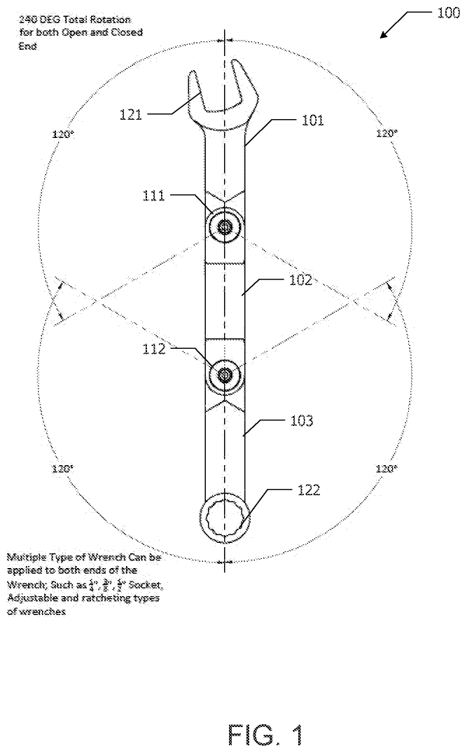

In general, the present disclosure relates to a hand tool for providing one hand tool to replace multiple other wrenches and or modifications of other wrenches for any user. To better understand the present invention, FIG. 1 represents one potential embodiment of general a three-segment hand tool for providing a hand tool for providing a multiple angle adjusting wrench according to the present invention. The hand-held wrench 100 that has two pivot points 111,112 in the handle 102. These two pivot points 111-112 allow a user to adjust either or both ends of the hand-held wrench 100 to any angle necessary up to 190 degrees on either side of the handle with a push of the button, A gear within each pivot point 111-112 is spring loaded to lock back in place.

The wrench itself is constructed from three solid pieces, typically made of metal either using a mold, using a milling process or other manufacturing processes. The pieces include an open wrench segment 101, a center section segment 102, and a closed wrench segment 103. Each segment is a straight metal member having a first and a second end. The open-end wrench segment 101 has an open-ended wrench 121 at its first end and the first pivot joint 111 at its second end. The center section segment 102 has a first pivot point 111 at its first end and the second pivot joint 112 at its second end. The closed end wrench segment 103 has at the second pivot point 112 at its first end and a closed ended wrench 122 at its the second end.

The pivot points 111-112 themselves rotate from left to right. This arrangement of adjustable segments enable the hand-held wrench 100 perform equivalent functions performed by a “standard” wrench set, an “S” wrench set, a “Moon” wrench set, and an “Offset” wrench set with a set of adjustable wrenches 100 having a wrench head ranging in multiple sizes.

A spring 113a-b is in-between the center section segment 102 and cap 111. As the cap 111 is pushed inward the spring 113a-b compresses and so the wrench 100 can move to a new position. As the gear goes into a new position, the spring 113a releases and keeps the gear and wrench from moving.

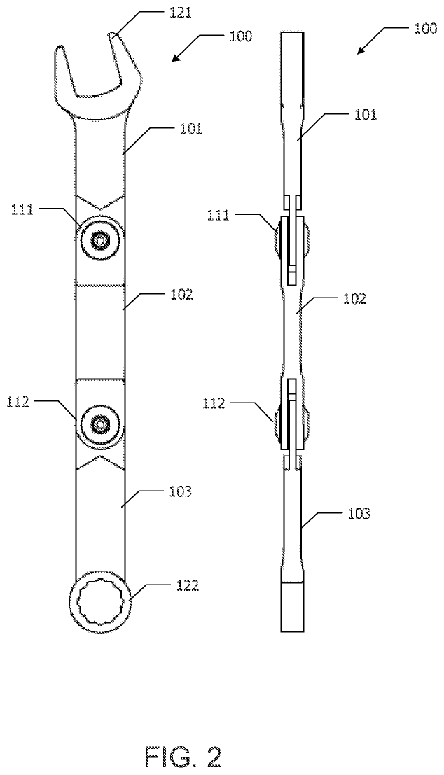

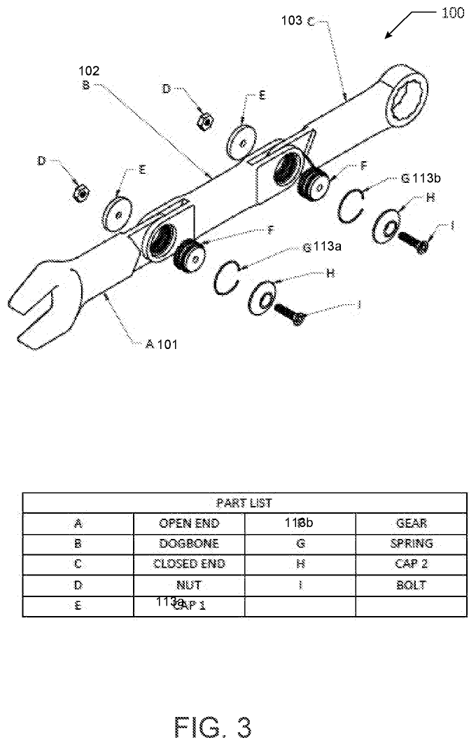

FIG. 2 illustrates another potential embodiment a hand tool for providing a hand tool for providing a multiple angle adjusting wrench according to the present invention. Both a front view 201 and a side view 202 of wrench 100 is shown. The wrench 100 includes the three segments: the open wrench segment 101, the center section segment 102, and the closed wrench segment 103. The two pivot points 111-112 show end caps over a gear-spring combination shown in more detail in FIG. 3. A user depresses either of these buttons to change the orientation of the open wrench segment 101 or the closed wrench segment 103 relative to the center section segment 102. Each pivot point operates independently of the other.

Once the ends of the wrench 100 are adjusted into a desired orientation, the wrench 100 may be used as any other hand-held wrench. The pivot points may be adjusted at any time and as many times as needed to complete a task of tightening or loosening nuts and bolts. The segments may be returned to a straight orientation for use or storage when desired.

FIG. 3 illustrates one potential embodiment an exploded view of the components in an embodiment of three segment hand tool for providing a hand tool for providing a multiple angle adjusting wrench according to the present invention. The wrench 100 once again includes the three segments: the open wrench segment 101, the center section segment 102, and the closed wrench segment 103. The components of the pivot points 111-112 are also shown.

Each of the two pivot points 111-112 are constructed using a first end cap D, a gear element E, a spring F and a second end cap G. The gear element E engages matching gear threads within the pivot points to lock the segments into a desired orientation. The spring F is used to disengage the gear element E from the mating threads of the pivot point permitting the segments to rotate. Release of the spring F 113a-b returns the gear element E to its locked position. Both pivot points operate in the same manner. The first end cap D, the gear element E, and the second end cap G are all tighten together by a bolt and nut.

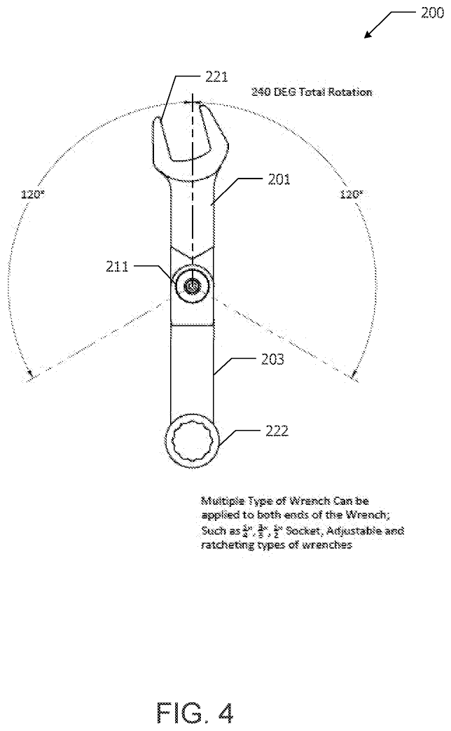

FIG. 4 represents one potential embodiment of general a two-segment wrench that provides multiple angles and adjustments according to the present invention. The hand-held wrench 200 that has a pivot point 211 in between the two wrench segments. This pivot point 211 allows a user to adjust each end of the hand-held wrench 200 to any angle necessary up to 190 degrees on either side of the handle with a push of the button, A gear within pivot point 211s spring 213 loaded to lock back in place.

The wrench 200 itself is constructed from two solid pieces, typically made of metal either using a mold, using a milling process or other manufacturing processes. The pieces include an open wrench segment 201 and a closed wrench segment 203. Each segment is a straight metal member having a first and a second end. The open-end wrench segment 201 has an open ended wrench 221 at its first end and the pivot joint 211 at its second end. The closed end wrench segment 203 has at the pivot point 211 at its first end and a closed ended wrench 222 at its the second end.

The pivot point 211 rotates from left to right. This arrangement of adjustable segments enable the hand-held wrench 200 perform equivalent functions performed by a “standard” wrench set, an “S” wrench set, a “Moon” wrench set, and an “Offset” wrench set with a set of adjustable wrenches 200 having a wrench head ranging in multiple sizes.

A spring 213 is in-between the open-ended wrench 221 and cap 211. As the cap 211 is pushed inward the spring 213 compresses and so the wrench 200 can move to a new position. As the gear goes into a new position, the spring 213 releases and keeps the gear and wrench from moving.

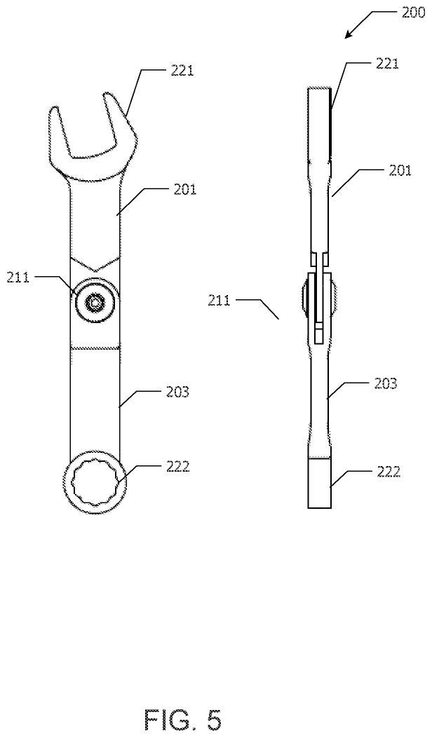

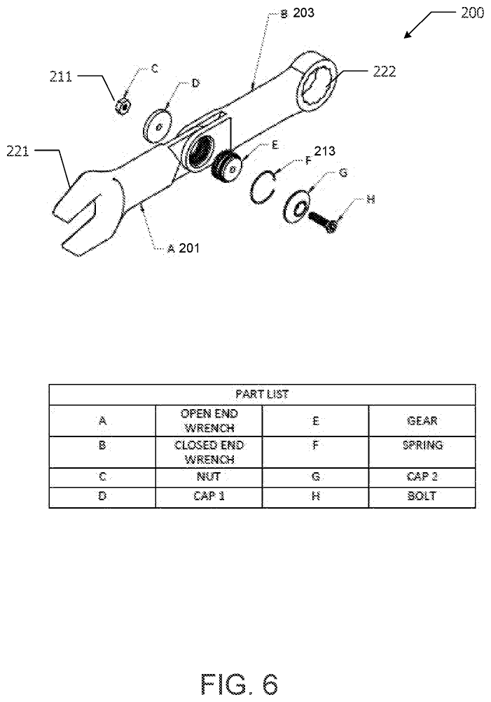

FIG. 5 illustrates another potential embodiment wrench that provides multiple angles and adjustments according to the present invention. Both a front view 231 and a side view 232 of wrench 200 is shown. The wrench 200 includes the two segments: the open wrench segment 201 and the closed wrench segment 203. The pivot point 211 show end caps over a gear-spring combination shown in more detail in FIG. 6. A user depresses either of these buttons to change the orientation of the open wrench segment 201 or the closed wrench segment 203 relative to each other.

Once the wrench 200 are adjusted into a desired orientation, the wrench 200 may be used as any other hand-held wrench. The pivot point may be adjusted at any time and as many times as needed to complete a task of tightening or loosening nuts and bolts. The segments may be returned to a straight orientation for use or storage when desired.

FIG. 6 illustrates one potential embodiment an exploded view of the components in an embodiment of hand tool for providing wrench that provides multiple angles and adjustments according to the present invention. The wrench 200 once again includes the three segments: the open wrench segment 201 and the closed wrench segment 203. The components of the pivot point 211 are also shown.

The pivot point 211 is constructed using a first end cap D, a gear element E, a spring F and a second end cap G. The gear element E engages matching gear threads within the pivot points to lock the segments into a desired orientation. The spring F 213 is used to disengage the gear element E from the mating threads of the pivot point permitting the segments to rotate. Release of the spring F 213 returns the gear element E to its locked position. The pivot point 211 operates in the same manner as described above. The first end cap D, the gear element E, and the second end cap G are all tighten together by a bolt and nut.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

I/We claim:

1. An adjustable wrench comprising
(a) a center handle segment;
(b) an open wrench end segment pivotally attached to the center segment;
(c) a closed wrench end segment pivotally attached to the center segment;
(d) two pivot point assemblies comprising:
(i) two gear and spring components,
(ii) two end cap components to house the gears and springs.

2. The wrench of claim 1, wherein, the pivot points can be adjusted up to 190 degrees on either side of the handle.

3. The wrench of claim 1, wherein, the gears and springs of the pivot points serve as locking mechanisms to lock and unlock the orientation of the segments.

4. The wrench of claim 1, wherein, the pivot point assemblies serve as button mechanisms that unlock the segments when depressed and lock the segments when released.

5. An adjustable wrench comprising
(a) an open wrench end segment pivotally attached to the closed wrench end segment;
(b) a closed wrench end segment pivotally attached to the open wrench end segment;
(c) one pivot point assembly comprising:
(i) a gear and spring component,
(ii) two end cap components to house the gear and spring components.
(d) The wrench of claim 5, wherein, the pivot point can be adjusted up to 190 degrees on either side of the wrench ends.
(e) The wrench of claim 5, wherein, the gear and spring components of the pivot point serves as a locking mechanism to lock and unlock the orientation of the segments.
(f) The wrench of claim 5, wherein, the pivot point assembly serves as a button mechanism that unlocks the segments when depressed and locks the segments when released.
